(19) United States
(12) Patent Application Publication
(10) Pub. No.: US 2023/0227661 A1
(43) Pub. Date: Jul. 20, 2023

(54) COMPOSITION FOR COATING AN OVERHEAD CONDUCTOR

(71) Applicant: CABLE COATINGS LIMITED, Leeds (GB)

(72) Inventors: Niall COOGAN, Armely (GB); Rachel PARKER, Leeds (GB)

(21) Appl. No.: 18/009,387

(22) PCT Filed: Jul. 1, 2021
(86) PCT No.: PCT/EP2021/068154

§ 371 Date: Dec. 9, 2022

(30) Foreign Application Priority Data
Jul. 1, 2020 (GB) 2010054.1
Jul. 28, 2020 (LU) LU101950
Sep. 11, 2020 (LU) 2014340.0

(51) Int. Cl. C09D 1/00; C09D 5/10; C09D 7/61; C09D 7/65; C09D 7/80; C09D 5/08

(52) U.S. Cl. CPC C09D 1/00; C09D 5/106; C09D 7/61; C09D 7/65; C09D 7/80; C09D 5/084

(57) ABSTRACT

The present invention provides a composition for coating an overhead conductor comprising: a binder which comprises a solvent and silica, organically modified silica, titanium oxide, aluminium oxide, zirconium oxide, iron oxide or a combination thereof; and an anti-corrosion agent, wherein the anti-corrosion agent is selected from an inhibitor pigment; a sacrificial pigment; a superhydrophobic agent; and combinations thereof.

### FIELD OF THE INVENTION

The present invention relates to anti-corrosion compositions for coating electric overhead conductors. The coatings are produced using a sol-gel method, and can prevent or hinder corrosion of the coated conductor. Such coatings may be useful in, for example, a desert environment, where highly corrosive salt laden moisture or dew can form on a conductor overnight or first thing in the morning.

### BACKGROUND

Various different types of high voltage electric overhead conductors are known comprising aluminium cables suspended between pylons. The various different types of known high voltage electric overhead conductors can be divided into two groups. The first group comprises conductors which have a maximum operating temperature of 80° C. The second group comprises conductors which have a higher maximum operating temperature in the range of 150-250° C.

Overhead conductors suffer from corrosion due to constant exposure to atmospheric conditions. For example, a desert environment can be highly corrosive due to salts from the desert and from the sea or ocean. In particular, at night in a desert environment when the dew point is reached, significant moisture can collect on the lines. The moisture will then enter the core of the overhead conductor which will serve to rapidly accelerate the corrosion of the core.

Furthermore, high ultra violet (“UV”) irradiation, high temperatures (which accelerate corrosion kinetics) and atmospheric pollutants such as NOx and SOx serve to make desert environments potentially highly corrosive environments.

Accordingly, in many cases, the steel cores of aluminium conductor steel-reinforced cable (ACSR) conductors will corrode rapidly. The conductors will also suffer from surface pitting and crevice corrosion which can reduce the usable life of the conductor. Ultimately, corrosion of the core will result in the lines needing replacing.

These phenomena are particularly pronounced on lines which are temporarily or permanently lightly loaded as they in turn operate at near ambient temperature.

The present invention is therefore concerned with preventing corrosion of overhead conductors. This may be particularly useful in environments such as deserts, where highly corrosive dew or salt laden moisture can form either overnight or first thing in the morning on an overhead conductor.

As well as protecting against corrosion, it is also desired that coatings for an overhead conductor can reduce the operating temperature of the conductor, whilst also not suffering from some of the problems which conventional coatings suffer from, such as poor optical properties, discoloration over time and poor corrosion resistance.

The present invention is therefore also concerned with providing an overhead conductor capable of operating at elevated temperatures (e.g. in the range of 150-250° C.), which is less prone to discolouration by accreting dirt and environmental pollutants and hence which shows a reduced or negligible loss in performance over time by virtue of the conductor remaining white for an extended period of time.

The present invention also provides coating compositions that can be prepared easily and at low temperatures, and coatings which will last a long time.

WO 2017/192864 discloses a coating composition that reduces ice adherence and minimises ice accumulation on overhead conductors. The coating composition comprises a polymeric binder (e.g. a water based fluoroethylene vinyl ether copolymer

“FEVE”) and a film forming lubricant. The film forming lubricant may comprise a water based cyclo silicone lubricant or a polymeric resin with perfluoroalkyl chains.

WO 2015/200146 discloses UV-resistant superhydrophobic coating compositions for substrates such as conductors. The coating compositions comprise a polymer binder comprising a fluoropolymer or an epoxy polymer resin.

In contrast to these known coating compositions, the coating composition of the present invention is formed using a primarily inorganic binder. This helps to achieve a longer-lasting coating, since an inorganic coating such as silica has the potential to last 30-50 years, compared with a maximum useful life of around 20 years for an organic coating.

The inorganic binders used in the present invention can also be produced quickly and simply, and at low temperatures, through use of a sol-gel process.

### SUMMARY OF THE INVENTION

According to an aspect of the present invention there is provided a composition for coating an overhead conductor, the composition comprising:
a binder which comprises a solvent and silica, organically modified silica, titanium oxide, aluminium oxide, zirconium oxide, iron oxide or a combination thereof; and
an anti-corrosion agent, wherein the anti-corrosion agent is selected from an inhibitor pigment; a sacrificial pigment; a superhydrophobic agent; and combinations thereof.

According to another aspect of the present invention there is provided a cured coating comprising:
a matrix which comprises silica, organically modified silica, titanium oxide, aluminium oxide, zirconium oxide, iron oxide or a combination thereof; and
an anti-corrosion agent, wherein the anti-corrosion agent is selected from an inhibitor pigment; a sacrificial pigment; a superhydrophobic agent; and combinations thereof.

According to another aspect of the present invention there is provided a method for forming a coating composition, the method comprising:
forming a binder which comprises a solvent and silica, organically modified silica, titanium oxide, aluminium oxide, zirconium oxide, iron oxide or a combination thereof by a sol-gel process;
adding an anti-corrosion agent, wherein the anti-corrosion agent is selected from an inhibitor pigment; a sacrificial pigment; a superhydrophobic agent; and combinations thereof.

According to another aspect of the present invention there is provided a sol-gel method for forming a coating composition, the method comprising:
(i) at least partially hydrolysing a precursor selected from a silicon alkoxide, an organosilane, a titanium alkoxide, an aluminium alkoxide, a zirconium alkoxide, an iron alkoxide or a combination thereof;
(ii) at least partially polymerising the product of step (i) to form silica, organically modified silica, titanium oxide, aluminium oxide, zirconium oxide, iron oxide or a combination thereof;
(iii) adding an anti-corrosion agent, wherein the anti-corrosion agent is selected from an inhibitor pigment; a sacrificial pigment; a superhydrophobic agent; and combinations thereof.

Steps (i) and (ii) may occur as discrete steps, or may occur together in a single step.

A solvent will be present in the final product. Generally, the precursor will be present in a solvent. Step (i) may therefore comprise at least partially hydrolysing a precursor in a solvent, wherein the precursor is selected from a silicon alkoxide, an organosilane, a titanium alkoxide, an aluminium alkoxide, a zirconium alkoxide, an iron alkoxide or a combination thereof.

According to another aspect of the present invention there is provided a method for forming a coating, the method comprising applying the coating composition of the invention to at least a portion of an overhead conductor, and allowing the composition to cure.

According to another aspect of the present invention there is provided a kit comprising:
a first part comprising a solvent and a precursor selected from a silicon alkoxide, an organosilane, a titanium alkoxide, an aluminium alkoxide, a zirconium alkoxide, an iron alkoxide or a combination thereof; and
a second part comprising an anti-corrosion agent, wherein the anti-corrosion agent is selected from an inhibitor pigment; a sacrificial pigment; a superhydrophobic agent; and combinations thereof.

In use, the first part of the kit is allowed to hydrolyse and polymerize by a sol-gel process. The first and second parts of the kit are then mixed together to form a composition which is applied to at least a portion of an overhead conductor and allowed to cure in order to form a coating on at least a portion of the overhead conductor.

According to another aspect of the present invention there is provided a kit comprising:
a first part comprising a binder which comprises a solvent and silica, organically modified silica, titanium oxide, aluminium oxide, zirconium oxide, iron oxide or a combination thereof; and
a second part comprising an anti-corrosion agent, wherein the anti-corrosion agent is selected from an inhibitor pigment; a sacrificial pigment; a superhydrophobic agent; and combinations thereof.

In use, the first and second parts of the kit are mixed together to form a composition which is applied to at least a portion of an overhead conductor and allowed to cure in order to form a coating on at least a portion of the overhead conductor.

According to another aspect of the present invention there is provided an overhead conductor at least partially coated with a composition of the invention, wherein, in use, the composition is cured so as to form a coating on at least a portion of the overhead conductor.

According to another aspect of the present invention there is provided an overhead conductor at least partially coated with a cured coating of the invention.

### FIGURES

Various embodiments of the present invention together with other arrangements given for illustrative purposes will now be described, by way of example only, and with reference to the accompanying drawings.

FIG. 1 illustrates the structure of silica.

FIG. 2 illustrates the structure of an organically modified silica.

### DETAILED DESCRIPTION

According to an aspect of the present invention there is provided a composition for coating an overhead conductor, the composition comprising:
a binder which comprises a solvent and silica, organically modified silica, titanium oxide, aluminium oxide, zirconium oxide, iron oxide or a combination thereof; and
an anti-corrosion agent, wherein the anti-corrosion agent is selected from an inhibitor pigment; a sacrificial pigment; a superhydrophobic agent; and combinations thereof.

### Binder

As well as a solvent, the binder comprises silica, organically modified silica, titanium oxide, aluminium oxide, zirconium oxide, iron oxide or a combination thereof. This component may be considered to be a network forming component, in that it forms a 3-dimensional (3D) network within the final coating.

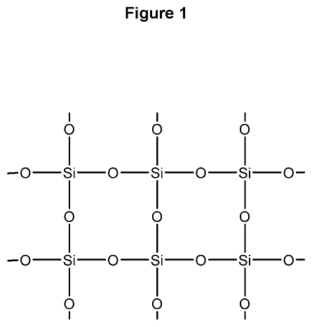

For example, the structure of silica is shown in FIG. 1. Silica comprises a 3D network of Si—O—Si bonding, and therefore can be considered to be a network forming component. As will be appreciated by the skilled person, the structure shown in FIG. 1 is depicted in 2D, but in reality would actually be a 3D structure comprising Si—O—Si bonding, i.e. a 3D network of SiO₂.

Alternatively, the silica, organically modified silica, titanium oxide, aluminium oxide, zirconium oxide, iron oxide or a combination thereof may be considered to be a matrix phase. Thus, in one aspect the invention can be considered to comprise a binder which comprises a solvent and a matrix which is selected from the group consisting of silica, organically modified silica, titanium oxide, aluminium oxide, zirconium oxide, iron oxide or a combination thereof.

The matrix is formed by a sol-gel process, and is therefore hydrolysed from precursor materials, typically in the presence of a catalyst such as an acid. As such, the binder may also comprise some of the precursor material(s).

The coating composition of the invention may therefore comprise a binder which comprises a solvent and (i) silica, organically modified silica, titanium oxide, aluminium oxide, zirconium oxide, iron oxide or a combination thereof; and (ii) a precursor of component (i). Put another way, the binder may comprise a solvent and (i) a matrix selected from the group consisting of silica, organically modified silica, titanium oxide, aluminium oxide, zirconium oxide, iron oxide or a combination thereof; and (ii) a precursor of the matrix.

Preferably, the binder comprises silica or organically modified silica, more preferably organically modified silica. That is, preferably the matrix is silica or organically modified silica, more preferably organically modified silica.

Suitable precursors for use in the present invention include silicon alkoxides, organosilanes containing at least two (and preferably three) Si—O bonds, titanium alkoxides, aluminium alkoxides, zirconium alkoxides, iron alkoxides or a combination thereof. One or more precursors may be used.

Silicon alkoxides have the formula Si(OR)₄, where each R is independently any suitable organic group, such as an alkyl group. Preferred R groups include C₁₋₈ alkyl, more preferably C₁₋₅ alkyl, and even more preferably methyl or ethyl. Particularly preferred silicon alkoxides include tetraethyl orthosilicate (TEOS) and tetramethyl orthosilicate (TMOS).

The organosilanes suitable for use as precursors in the present invention must comprise at least two Si—O bonds. That is, suitable organosilanes must contain two or three, preferably three, Si—O bonds. For example, suitable organosilanes may have the formula SiR₂(OR)₂ or SiR(OR)₃, where each R is independently any suitable organic group, such as an alkyl, vinyl or epoxy group.

Preferred organosilanes have the formula SiR₂(OR¹)₂ or SiR(OR¹)₃, where each R¹ group is independently any suitable organic group, preferably an alkyl group, more preferably C₁₋₈ alkyl, even more preferably C₁₋₅ alkyl, and most preferably methyl or ethyl. Each R group may independently be any suitable organic group (such as an alkyl, vinyl or epoxy group), although it is preferred that each R group does not contain more than 16 non-hydrogen and non-fluorine atoms. More preferably, each R group does not contain more than 16 non-hydrogen and non-fluorine atoms, and even more preferably each R group does not contain more than 8 non-hydrogen and non-fluorine atoms.

Particularly preferred organosilanes suitable for use as precursors in the present invention include methyltrimethoxy silane (MTMS), vinyltrimethoxysilane (VTMS), triethoxyvinylsilane (TEVS), trimethoxyphenylsilane, triethoxyphenylsilane,
(3-aminopropyl)triethoxysilane (APTES), triethoxy(octyl)silane (C8-TEOS),
3-(2-aminoethylamino)propyldimethoxymethylsilane (AEAPS),
(3-glycidyloxypropyl)trimethoxysilane (GPTMS),
[3-(methacryloyloxy)propyl]trimethoxysilane (MAPTS), hexadecyltrimethoxysilane,
(3-mercaptopropyl)trimethoxysilane (MPTMS), 1H,1H,2H,2H-perfluorooctyltriethoxysilane (FOTS), and 1H,1H,2H,2H-perfluorodecyltriethoxysilane (PFDTES).

As the skilled person would recognise, the use of silicon-based precursors such as the silicon alkoxides and organosilanes listed above in the present invention would result in the formation of a binder comprising silica or organically modified silica.

In addition, organically modified silica can also be formed by co-hydrolysing a silicon alkoxide (for example those listed above, such as TEOS) with an auxiliary resin which forms part of the organically modified silica polymer network. Accordingly, according to various embodiments one or more auxiliary resins may be added to the precursor. Suitable auxiliary resins include polysiloxanes such as polydimethylsiloxane (PDMS). This can cross link into the silica network introducing some elasticity and thereby increase flexibility of the coating. Thus, organically modified silica can be formed by co-hydrolysing a silicon alkoxide (for example those listed above, such as TEOS) with a polysiloxane such as PDMS.

In contrast, titanium, zirconium, iron or aluminium based precursors may be used to form binders comprising titanium oxide, aluminium oxide, zirconium oxide or iron oxide respectively. Examples of suitable titanium, zirconium, iron or aluminium based precursors include titanium, zirconium, iron and aluminium alkoxides, such as zirconium tert-butoxide, zirconium propoxide and aluminium isopropoxide.

A combination of silicon, titanium, zirconium, iron or aluminium based precursors can also be used to form the binder. For example, a combination of zirconium-based precursors and silicon-based precursors can be used. In this case, the binder will comprise silica and zirconium oxide. Alternatively, the combination could be of aluminium-based precursors and silicon-based precursors. In this case, the binder will comprise silica and aluminium oxide.

Preferably, the precursor comprises tetraethyl orthosilicate (TEOS), optionally in combination with one or more other precursor such as those listed above. For example, particularly preferred combinations of precursors include tetraethyl orthosilicate and triethoxyvinylsilane.

To form the binder, the precursor (e.g. TEOS) is firstly hydrolysed as follows:

M(OR)₄+H₂O→M(OH)₄+4R—OH

where M is Si, Ti, Al, Zr, or Fe, preferably Si.

The above reaction is often catalysed, for example using an acid such as HCl or a base such as ammonia.

Secondly, the hydroxide product condenses and polymerises to form an oxide. This process proceeds as follows:

M(OH)₄→MO₂+2H₂O

The above reaction is often catalysed, for example using an acid such as HCl or a base such as ammonia.

Although shown as separate stages in the reactions described above, the hydrolysis and polymerisation stages may occur simultaneously.

In addition, by use of certain precursors, organic components may be incorporated within the matrix phase. For example, the above-mentioned organosilanes can be used to form a silica structure which will contain residual organic groups. This is because complete hydrolysis of the precursor is not possible, due to the Si—C bond.

For example, hydrolysis of an organosilane may proceed as follows:

SiR₂(OR)₂+H₂O→SiR₂(OH)₂+2R—OH

SiR₂(OH)₂→organically modified silica+2H₂O

or

SiR(OR)₃+H₂O→SiR(OH)₃+3R—OH

SiR(OH)₃→organically modified silica+2 H₂O

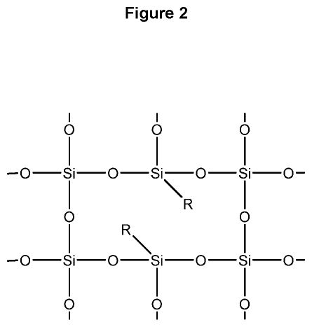

An example of an organically modified silica structure formed using an organosilane precursor is shown in FIG. 2.

An advantage of organically modified silica over the purely inorganic matrix phases discussed above (e.g. silica, titanium dioxide, etc.) is that it can have the properties of both organic polymers and inorganics, such as mechanical flexibility due to the organic component, and good chemical durability due to the inorganic component. It is also possible to tune the physical properties of organically modified silica by changing the organic group(s) and the concentration of the organic group(s).

Regardless of the precursor used, some precursor is generally present in the binder of the coating composition, due to incomplete hydrolysis. Thus, as discussed above, the binder may comprise a solvent and (i) silica, organically modified silica, titanium oxide, aluminium oxide, zirconium oxide, iron oxide or a combination thereof; and (ii) a precursor to component (i).

For example, the binder may comprise a solvent, silica and a silicon alkoxide (e.g. TEOS). Alternatively, the binder may comprise a solvent, organically modified silica and an organosilane containing at least two Si—O bonds (e.g. triethoxyvinylsilane) and optionally also a silicon alkoxide (e.g. TEOS).

Preferably, the coating composition of the invention comprises at least about 45 wt. % or about 50 wt. % binder. More preferably, the composition comprises at least about 70 wt. % binder. Even more preferably, the composition comprises at least about 80 wt. % binder. Most preferably, the composition comprises at least about 90 wt. % binder.

Within the binder it is preferred that at least about 50 wt. %, more preferably at least about 60 wt. %, and even more preferably at least about 70 wt. %, of the binder is silica, organically modified silica, titanium oxide, aluminium oxide, zirconium oxide, iron oxide or a combination thereof, based on the total weight of binder and precursor excluding solvents.

However, since silica, organically modified silica, titanium oxide, aluminium oxide, zirconium oxide and iron oxide are solids, it is preferred that less than about 95 wt. %, more preferably less than about 90 wt. %, of the binder is silica, organically modified silica, titanium oxide, aluminium oxide, zirconium oxide, iron oxide or a combination thereof, based on the total weight of binder and precursor excluding solvents.

The binder therefore generally comprises from about 5 to about 50 wt. % precursor, more preferably from about 10 to about 30 wt. % precursor, based on the total weight of binder and precursor excluding solvents.

Thus, the binder may comprise (i) from about 50 wt. % to about 95 wt. % silica, organically modified silica, titanium oxide, aluminium oxide, zirconium oxide, iron oxide or a combination thereof; and (ii) from about 5 wt. % to about 50 wt. % of a precursor to component (i), based on the total weight of (i) and (ii).

More preferably, the binder comprises (i) from about 70 wt. % to about 90 wt. % silica, organically modified silica, titanium oxide, aluminium oxide, zirconium oxide, iron oxide or a combination thereof; and (ii) from about 10 wt. % to about 30 wt. % of a precursor to component (i), based on the total weight of (i) and (ii).

The binder also comprises a solvent, preferably an alcohol. Preferably, the alcohol is selected from the group consisting of ethanol, isopropanol, 2-butoxyethanol, 2-ethoxyethanol, butanol, and combinations thereof. More preferably, the alcohol is ethanol, isopropanol, or a combination thereof.

Generally any water present is used in the hydrolysis. The binder therefore generally comprises 10 wt. % or less water, preferably 5 wt. % or less water, more preferably 1 wt. % or less water, and most preferably 0.1 wt. % less of water.

The overall composition may therefore comprise 10 wt. % or less water, preferably 5 wt. % or less water, more preferably 1 wt. % or less water, and most preferably 0.1 wt. % of less water.

The solvent is generally present in the binder in the amount of from about 50 wt. % to about 90 wt. %, preferably from about 60 wt. % to about 80 wt. % or from about 70 wt. % to about 90 wt. %, based on the total weight of the binder.

Based on the total weight of the coating composition, the solvent may be present in the coating composition in the amount of from about 25 wt. % to about 90 wt. %, preferably from about 45 wt. % to about 90 wt. %, more preferably from about 50 wt. % to about 90 wt. %, and most preferably from about 60 wt. % to about 80 wt %.

As discussed above, the coating composition of the present invention is formed using a primarily inorganic binder. Thus, preferably the binder contains no organic polymers, including fluoropolymers or epoxy polymer resins (e.g. as used in WO 2015/200146) and silicone polymers (e.g. as used in WO 2017/192864).

More generally, the coating composition of the present invention preferably contains less than about 5 wt. % organic polymers, more preferably less than 1 wt. % organic polymers.

### Anti-Corrosion Agent

The coatings formed from the coating composition of the present invention are corrosion resistant. This is at least partially due to the presence of an anti-corrosion component in the coating composition. One or more anti-corrosion agents may be used. The anti-corrosion agent is selected from an inhibitor pigment; a sacrificial pigment; a superhydrophobic agent; and combinations thereof. One or more of each of the inhibitor pigment, sacrificial pigment and superhydrophobic agent may be used.

In each case, the anti-corrosion agent is preferably present in the amount of less than 50 wt. % of the coating composition, more preferably from about 0.01 to about 20 wt. %, even more preferably from about 0.1 to about 10 wt. %, and most preferably from about 0.5 to about 2 wt. %, based on the total weight of the composition. Alternatively, the anti-corrosion agent may be present in the amount of from about 1 to about 10 wt. %, preferably from about 2 to about 6 wt. %, even more preferably from about 3 to about 5 wt. %.

The anti-corrosion agent is added after formation of the matrix. That is, the binder is formed and then the anti-corrosion agent is added.

### Inhibitor Pigment

Inhibitor pigments (also termed inhibitor agents) are agents which inhibit corrosion.

Suitable inhibitor pigments/agents include, but are not limited to, cerium oxide (preferably cerium oxide nanoparticles), cerium molybdate (preferably cerium molybdate nanowires), cerium nitrate, vanadium based reagents, zinc oxide, niobium, boehmite, zinc molybdate, calcium molybdate, strontium molybdate, zinc phosphate, calcium phosphate, calcium-modified silica, zinc 5-nitroisopthalate, calcium hydroxyphosphate, magnesium hydrogen orthophosphate, calcium magnesium orthophosphate, calcium strontium phosphosilicate, zinc calcium strontium aluminium orthophosphate silicate, calcium aluminium polyphosphate silicate, strontium aluminium polyphosphate, zinc aluminium molybdenum orthophosphate, zinc aluminium polyphosphate, and zinc molybdenum orthophosphate. These inhibitors may be used singly or in combination.

Preferred inhibitor pigments/agents include zinc oxide, niobium, boehmite, zinc molybdate, calcium molybdate, strontium molybdate, zinc phosphate, calcium phosphate, calcium-modified silica, zinc 5-nitroisopthalate, calcium hydroxyphosphate, magnesium hydrogen orthophosphate, calcium magnesium orthophosphate, calcium strontium phosphosilicate, zinc calcium strontium aluminium orthophosphate silicate, calcium aluminium polyphosphate silicate, strontium aluminium polyphosphate, zinc aluminium molybdenum orthophosphate, zinc aluminium polyphosphate, zinc molybdenum orthophosphate, and combinations thereof.

Particularly preferred inhibitor pigments/agents include zinc molybdate, calcium molybdate, zinc phosphate, calcium phosphate, and combinations thereof.

As used herein the term “nanoparticles” means particles that exist on a nanometre scale, i.e. at least one dimension is less than 1000 nm, preferably less than about 500 nm. Preferably, the longest dimension is less than 1000 nm, more preferably less than about 500 nm. Thus, preferably all the dimensions are less than 1000 nm, more preferably less than about 500 nm. More preferably, the nanoparticles are spherical, having a diameter of less than 1000 nm, more preferably less than about 500 nm.

As used herein the term “nanowires” means a structure having a thickness or diameter of less than 1000 nm, preferably less than about 500 nm, but having an unconstrained length. Typically, nanowires having a length-to-width ratio of 1000 or more.

### Sacrificial Pigment

Sacrificial pigments (also termed sacrificial agents) are compounds which preferentially corrode over the underlying substrate. Coatings containing a sacrificial pigment will therefore protect the underlying substrate (e.g. a conductor) from corrosion.

Suitable sacrificial pigments/agents would be known to those skilled in the art. Examples of suitable sacrificial pigments/agents which may be used in the present invention include, but are not limited to, metallic zinc and metallic aluminium. The metallic aluminium is preferably in the form of flakes.

### Superhydrophobic Agent

It is also possible to reduce corrosion by superhydrophobicity, since superhydrophobic coatings can prevent water remaining on the coated substrate and corroding said substrate. The coatings of the present invention can be rendered superhydrophobic by integrating components which substantially increase the repellance of water, i.e. a superhydrophobic agent.

Examples of suitable superhydrophobic agents which may be used in the present invention include, but are not limited to silica nanoparticles which have been surface modified with hydrophobic silanes. Suitable hydrophobic silanes would be known to the skilled person, and include, for example, hexamethyldisilazane (HMDS), tetraethyl orthosilicate (TEOS), tetramethyl orthosilicate (TMOS), methyltrimethoxy silane (MTMS), vinyltrimethoxysilane (VTMS), trimethoxyphenylsilane, (3-aminopropyl)triethoxysilane (APTES), trimethylchlorosilane (TMCS), triethoxy(octy)silane (C8-TEOS), 3-(2-aminoethylamino)propyldimethoxymethylsilane (AEAPS), (3-glycidyloxypropyl)trimethoxysilane (GPTMS), [3-(methacryloyloxy)propyl]trimethoxysilane (MAPTS), hexadecyltrimethoxysilane, (3-mercaptopropyl)trimethoxysilane (MPTMS), triethoxyphenylsilane, 1H,1H,2H,2H-perfluorooctyltriethoxysilane, trichloro(1H,1H,2H,2H-perfluorooctyl)silane (PFOCTS), 1H,1H,2H,2H-perfluorodecyltriethoxysilane (PFDTES) and tridecafluorooctyltriethoxysilane. In particular, after the silica nanoparticle has been surface treated the materials can be dried to form a fumed silica powder which then can be incorporated into the composition as a dry reagent. Commercially available fumed silicas include Aerosil R 972 Evonik® which is a fumed silica after having been treated with dimethyldichlorosilane (“DDS”) and Aerosil® R 812 which is a fumed silica after having been treated with hexamethyldisilazane (HMDS).

Alternative superhydrophobic agents include functional polysiloxanes which impart a strong hydrophobic effect. The functional polysiloxane may be modified with one or more amine or fluoro-containing groups. The polysiloxane additives may be added in the amount of from about 1 to about 5 wt. % of the total formulation and may be modified with amine groups or fluoro-containing groups. These systems can be water based or solvent free. Commercially available examples include Silsan 1300®, TEGO Phobe 1505® and RUCOSIL B-HS®.

Other alternative superhydrophobic agents includes polymethylsilsesquioxanes.

Any of the above-mentioned anti-corrosion agents may be used in the coating compositions in combination. For example, the compositions of the present invention may comprise two or more superhydrophobic agents.

Preferably, the anti-corrosion agent comprises at least one superhydrophobic agent. For example, the anti-corrosion agent may comprise (or consist of) an inhibitor pigment and at least one superhydrophobic agent; a sacrificial pigment and at least one superhydrophobic agent; or a sacrificial pigment, an inhibitor pigment and at least one superhydrophobic agent.

Preferably, the coating composition comprises from about 1 to about 10 wt. % inhibitor pigment or sacrificial pigment (preferably inhibitor pigment) and from about 0.1 to about 5 wt. % superhydrophobic agent. More preferably, the coating composition comprises from about 2 to about 6 wt. % inhibitor pigment or sacrificial pigment (preferably inhibitor pigment) and from about 0.5 to about 2 wt. % superhydrophobic agent.

### Optional Additives

As well as the binder and the (one or more) anti-corrosion agent, the coating composition of the present invention may comprise a range of additional optional additives.

### Fillers

The coating composition may optionally comprise one or more fillers. The fillers may be useful to increase the mineral content and ultimate thickness of the coating.

Suitable fillers include, but are not limited to, white fillers. The white filler may comprise: (i) magnesium oxide (MgO); (ii) calcium oxide (CaO); (iii) aluminium oxide (Al₂O₃); (iv) calcium carbonate (CaCO₃); (v) aluminium silicate (Al₂SiO₅); (vi) kaolin (Al₂O₃·2SiO₂); (vii) titanium dioxide (TiO₂); or (viii) barium sulphate (BaSO₄). Other suitable fillers include calcium carbonate (CaCO₃), calcined kaolin (Al₂O₃·2SiO₂) or talc (e.g. hydrated magnesium silicate (H₂Mg₃(SiO₃)₄ or Mg₃Si₄O₁₀(OH)₂)).

If present, the total amount of any fillers preferably ranges from about 1 to about 50 wt. % of the coating composition, such as from about 1 to about 10 wt. %.

The one or more fillers may have an average particle size of 0.1-50 μm. The filler particles may be spherical, hexagonal, flake like, fibres or ribbon like.

### Reflective Additives

The coating composition may optionally comprise one or more reflective pigments or additives. These additives may be useful as a means to keep the temperature of the cable from rising above the optimum, particularly in an environment where the cable is exposed to large amounts of solar radiation, e.g. in a desert. The reflective pigment is preferably an infrared reflective (“IR”) pigment.

If present, the total amount of any reflective pigments preferably ranges from about 0.1 to about 25 wt. %, such as from about 0.1 to about 23 wt. % or about 10 to about 22 wt. % of the coating composition.

Alternatively, the total amount of any reflective pigments may range from about 0.1 to about 15 wt. %, such as from about 0.1 to about 10 wt. % or about 10 to about 15 wt. % of the coating composition.

Suitable reflective additives include, but are not limited to, copper, cobalt, aluminium, bismuth, lanthanum, lithium, magnesium, neodymium, niobium, vanadium, ferrous, chromium, zinc, titanium, manganese, and nickel based metal oxides and ceramics. Particularly preferred reflective additives include rutile titanium dioxide (TiO₂), sodium aluminosilicate (AlNa₁₂SiO₅), zinc oxide (ZnO) and copper oxide (CuO), most preferably rutile titanium dioxide.

Preferably, the reflective pigment comprises rutile titanium dioxide, and the total amount of rutile titanium dioxide ranges from about 0.1 to about 15 wt. %, such as from about 0.1 to about 10 wt. % or about 10 to about 15 wt. % of the coating composition. The rutile titanium dioxide preferably has an average particle size (“aps”) of ≥100 nm.

The rutile titanium dioxide (TiO₂) which is preferably provided as a reflective agent preferably has an average particle size (“aps”) of: (i) 100 nm; (ii) 100-200 nm; (iii) 200-300nm; (iv) 300-400 nm; (v) 400-500 nm; (vi) 500-600 nm; (vii) 600-700 nm; (viii) 700-800 nm; (ix) 800-900 nm; or (x) 900-1000 nm.

The rutile titanium dioxide (TiO2) preferably comprises substantially spherical particles.

### Colorants

One or more colorants may be used in the coating composition, preferably at a concentration of about 0.02 to 0.2 wt %. The colorants can be organic or inorganic pigments, which include, but are not limited to, titanium dioxide, rutile, titanium, anatine, brookite, cadmium yellow, cadmium red, cadmium green, orange cobalt, cobalt blue, cerulean blue, aureolin, cobalt yellow, copper pigments, azurite, Han purple, Han blue, Egyptian blue, malachite, Paris green, phthalocyanine blue BN, phthalocyanine green G. Verdigris, viridian, iron oxide pigments, sanguine, caput mortuum, oxide red, red ochre, Venetian red, Prussian blue, clay earth pigments, yellow ochre, raw Sienna, burnt Sienna, raw umber, burnt umber, marine pigments (ultramarine, ultramarine green shade), zinc pigments (e.g. zinc white, zinc ferrite), and combinations thereof.

### Photocatalytic Agent

The coatings may accrete dirt on the conductor surface, which introduce undesirable effects over time. One method to deal with this includes the addition of a photocatalytic agent, which enables the photocatalytic conversion of any organic matter which may have adhered to the coating. For example, when anatase titanium dioxide (TiO₂) is excited by UV light it creates hydroxyl (OH⁻) and superoxide (O₂⁻) radicals which will decompose surface organic matter into carbon dioxide (CO₂) and water (H₂O).

The coating composition may therefore optionally comprise one or more photocatalytic pigments.

Suitable photocatalytic agents preferably comprises ≥70 wt % anatase titanium dioxide (TiO₂), preferably having an average particle size of ≤100 nm.

The photocatalytic agent may comprise ≥75%, ≥80%, ≥85%, ≥90%, ≥95% or ≥99% wt. % anatase titanium dioxide (TiO₂).

Preferably, the photocatalytic agent comprises a commercially available form of titanium dioxide (TiO₂) known as DEGUSSA (EVONIK)® P25 or AEROXIDE® TiO₂ P25. DEGUSSA (EVONIK)® P25 titanium oxide (TiO₂) is a conventional powdered form of titanium dioxide (TiO₂). The properties of P25 titanium oxide have been investigated in detail and reference is made to the Journal of Photochemistry and Photobiology A: Chemistry, 216(2-3): 179-182 which found that the powder comprised titanium dioxide (TiO2) in the ratio anatase:rutile:amorphous 78:14:8.

It is noted that DEGUSSA (EVONIK)® P25 is commonly reported as comprising 70:30, 80:20 or 85:15 anatase:rutile crystallites and that no reference is often made to the presence of the amorphous form of titanium dioxide (TiO₂).

It has been reported that the average particle size (“aps”) of the anatase titanium dioxide (TiO₂) in DEGUSSA (EVONIK)® P25 is approximately 85 nm and that the average particle size of rutile titanium dioxide (TiO₂) in DEGUSSA (EVONIK)® P25 is approximately 25 nm.

Titanium dioxide (TiO₂) is particularly preferred as a photocatalyst for decomposition of organic pollutants because it is chemically stable and biologically benign. The band gap of titanium dioxide (TiO₂) is larger than 3 eV (˜3.0 for rutile and ˜3.2 for anatase) thereby making pure titanium dioxide (TiO₂) primarily active for UV light.

It is believed that the specific phase mixture of different polymorphs of titanium dioxide (TiO₂) as are present in DEGUSSA (EVONIK)® P25 have a synergistic effect and an increased photocatalytic activity is observed compared to pure phases (i.e. either relative to pure rutile titanium dioxide (TiO₂) or to pure anatase titanium dioxide (TiO₂)).

It is also generally accepted that pure anatase titanium dioxide (TiO₂) exhibits a higher photocatalytic activity than pure rutile titanium dioxide (TiO₂).

It is known that anatase titanium dioxide (TiO₂) has a larger band gap than rutile titanium dioxide (TiO₂). While this reduces the light that can be absorbed, it may raise the valence band maximum to higher energy levels relative to redox potentials of adsorbed molecules. Accordingly, the oxidation power of electrons may be increased and electron transfer may be facilitated from the titanium dioxide (TiO₂) to the adsorbed molecules.

If present, the total amount of any photocatalytic pigment preferably ranges from about 1 to about 10 wt. % of the coating composition, more preferably from about 1 to about 5 wt. %, even more preferably from about 2 to about 4 wt. % or from about 1 to about 2 wt. % of the coating composition.

### Thickeners

The coating composition may optionally comprise one or more thickeners. These may be useful to improve the rheology of the coating composition.

Suitable thickeners include, but are not limited to, hydrophobically modified ethylenoxide urethane rheology modifier (“HUER”), organoclays, polyamides and fumed silicas.

If present, the total amount of any thickener preferably ranges from about 1 to about 3 wt. % of the coating composition.

### Wetting Agents/Dispersion Agents

The coating composition may optionally comprise one or more wetting agents and/or dispersion agents.

Suitable wetting agents and/or dispersion agents include, but are not limited to, polyacrylic acid, polyurethanes, polyacrylates, phosphoric acid esters or modified fatty acids. One example of a suitable wetting agent and/or dispersion agent is DeCAL 2076®.

If present, the total amount of any wetting agent and/or dispersion agent preferably ranges from about 0.5 to about 3 wt. % of the coating composition.

### Surfactant

One or more surfactants may also be used in the coating composition, preferably at a concentration of about 0.05 to about 0.5 wt. %. Suitable surfactants include, but are not limited to, cationic, anionic, or non-ionic surfactants, and fatty acid salts.

### Defoamer

One or more defomaers may also be used in the coating composition, preferably at a concentration of about 0.5 to about 3 wt. %. Suitable defomaers would be known to the skilled person and include, but are not limited to, polysiloxane-based, mineral oil-based, vegetable oil-based or polymeric defoamers.

### UV Curing Agents

The coating composition may optionally comprise one or more UV curing agents. These may be useful to propagate the curing reaction.

Suitable UV curing agents would be known to the skilled person and include, but are not limited to, a three component system including an a-aminoketone photoinitiator such as methyl-1[4-(methylthio)phenyI]-2-morpholinopropan-1-one (Omnirad 907, IGM), a photosensitizer such as benzophenone (BP), and an oxygen scavenger such as triphenylphosphine.

If present, the total amount of any UV curing agent preferably ranges from about 5 to about 7 wt. % of the coating composition. Each component within the UV curing agent is generally present in the same amount. Thus, the UV curing agent could comprise about 2 wt. % of each of the three components listed above. The UV curing agent as a whole would therefore be present in the amount of about 6 wt. % of the coating composition.

### Chemical Curing Catalyst

The coating composition may optionally comprise one or more chemical curing catalysts. These may be useful to propagate the hydrolysis-condensation reaction of the precursor.

Suitable chemical curing catalysts would be known to the skilled person and include, but are not limited to, dibutyltin dilaurate. Dibutyltin dilaurate can act as a catalyst for the hydrolysis-condensation reaction between two silanol terminated groups. This could include alkoxy silanes, fluoroalkysilanes and hydroxyl terminated polymers such as silanol terminated polydimethylsiloxane.

If present, the total amount of any chemical curing catalyst preferably ranges from about 0.1 to about 1 wt. % of the coating composition.

### UV Stabiliser

The coating composition may optionally comprise one or more UV stabilisers.

Suitable UV stabilisers would be known to the skilled person and include, but are not limited to, 2-(2H-benzotriazol-2-yl)-p-cresol, 2[4,6-bis-(2,4-dimethylphenyl)-1,3,5-triazin-2-yl]-5-(octyloxy)phenol, and hindered amine light stabilisers (“HALS”) such as bis(1-octyloxy-2,2,6,6-tetramethyl-4-piperidyl)sebacate and bis(1,2,2,6,6-pentamethyl-4-piperidyl)sebacate.

If present, the total amount of any UV stabiliser preferably ranges from about 0.5 to about 5 wt. % of the coating composition.

### Primer

The underlying substrate for the coating of the present invention is preferably aluminium metal. Adhesion to such a substrate can be improved by using a primer such as ethyl silicate direct to metal primer.

### Method of Forming the Composition

As discussed above, the compositions of the present invention are formed using a sol-gel process.

The first stage involves the hydrolysis and subsequent polymerisation of the precursor, to form the binder. As discussed above, at this stage the binder may comprise some residual precursor as well as a solvent and silica, organically modified silica, titanium oxide, aluminium oxide, zirconium oxide, iron oxide or a combination thereof.

At this stage, hydrolysis of the precursor is generally around 70-95% complete, such as about 70-90% complete. Full completion would result in the formation of a solid film of silica, organically modified silica, titanium oxide, aluminium oxide, zirconium oxide and/or iron oxide, which could not then be applied to a cable.

At this stage, the anti-corrosion agent(s) and any other optional components such as those discussed above can be added to the composition.

The present invention therefore provides a sol-gel method for forming a coating composition, the method comprising:
forming a binder which comprises a solvent and silica, organically modified silica, titanium oxide, aluminium oxide, zirconium oxide, iron oxide or a combination thereof by a sol-gel process;
adding an anti-corrosion agent, wherein the anti-corrosion agent is selected from an inhibitor pigment; a sacrificial pigment; a superhydrophobic agent; and combinations thereof.

Put another way, the present invention provides a sol-gel method for forming a coating composition, the method comprising:
(i) at least partially hydrolysing a precursor selected from a silicon alkoxide, an organosilane, a titanium alkoxide, an aluminium alkoxide, a zirconium alkoxide, an iron alkoxide or a combination thereof;
(ii) at least partially polymerising the product of step (i) to form silica, organically modified silica, titanium oxide, aluminium oxide, zirconium oxide, iron oxide or a combination thereof;
(iii) adding an anti-corrosion agent, wherein the anti-corrosion agent is selected from an inhibitor pigment; a sacrificial pigment; a superhydrophobic agent; and combinations thereof.

Steps (i) and (ii) may occur as discrete steps, or may occur together in a single step.

As discussed above, hydrolysis of the precursor within the coating composition is generally around 70-95% or 70-90% complete. The step of “at least partially hydrolysing the precursor” in the above-described methods therefore preferably comprises partially (but not fully) hydrolysing the precursor. Preferably, this step comprises hydrolysing from about 50 to about 80 wt. % of the precursor, more preferably from about 70 to about 95 wt. % or from about 70 to about 90 wt. % of the precursor.

The sol-gel process may be done in the presence of an acid, such as HCl, or in the presence of a base, such as ammonia.

### Method of Forming the Coating

After forming the sol-gel composition, the composition can then be applied to an overhead conductor and cured to form the final film or coating.

Thus, the present invention provides a method for forming a film or coating, the method comprising applying the coating composition of the invention to at least part of an overhead conductor, and allowing the composition to cure.

Suitable methods for applying the coating composition would be well-known to the skilled person. For example, the coating composition may be applied by spray coating, dip coating, or with a brush or roller.

Suitable overhead conductors include aluminium conductor steel reinforced (“ACSR”) cables, aluminium conductor steel supported (“ACSS”) cables, aluminium conductor composite core (“ACCC”) cables, all aluminium alloy conductor (“AAAC”) cables, and composite cables. The wires in the conductors can have a variety of cross sectional shapes including round and trapezoidal.

One or more pre-treatment processes may be used to prepare a surface of the conductor or one or more conductive wires for the coating. For example, the conductor or one or more conductive wires may be subjected to chemical treatment, pressurised air cleaning, hot water treatment, steam cleaning, brush cleaning, heat treatment, sand blasting, ultrasound, deglaring, solvent wipe, plasma treatment and the like.

A surface of one or more overhead conductors may be deglared by sand blasting. An overhead conductor may be heated to temperatures between 230-250° C. as part of a heat treatment process to prepare the surface of the conductor or one or more conductive wires for the coating or film. The temperature may be selected dependent upon the coating or film.

### Curing

Once applied to the substrate, the sol-gel coating composition may be cured by one of three different methods of curing, include humidity, thermal curing and UV curing.

Once applied, the composition may be cured for a period of <1 hour, 1-2 hours, 2-3 hours, 3-4 hours, 4-5 hours, 5-6 hours, 6-7 hours, 7-8 hours, 8-9 hours, 9-10 hours, 10-11 hours, 11-12 hours, 12-13 hours, 13-14 hours, 14-15 hours, 15-16 hours, 16-17 hours, 17-18 hours, 18-19 hours, 19-20 hours, 20-21 hours, 21-22 hours, 22-23 hours, 23-24 hours or >24 hours.

During the curing process, most of the remaining precursor which is present in the coating composition will be hydrolysed and polymerised, thereby forming a coating which contains very little precursor. For example, the amount of precursor in the final coating may be less than about 1 wt. %, preferably less than about 0.5 wt. %.

In addition, any solvent present in the binder will evaporate during the curing or film-forming process. Residual water present during the curing or film-forming process allows for the sol-gel process to continue, by facilitating the hydrolysis and condensation process discussed above. It is therefore preferred to have a relative humidity of over 50% during the curing step, since otherwise the water will evaporate before the curing process is complete, leading to partially formed films or coatings.

Sol-gel coatings can be cured at elevated temperatures, which can ensure rapid curing.

However, in contrast to other coating compositions, elevated temperatures are not required to achieve a full cure. This is advantageous because it can be difficult to heat a coating composition once it has been applied to an overhead cable.

Since the curing process reaction discussed above proceeds via the hydrolysis of Si—O bonds, an environment with a relative humidity of over 50% will facilitate this reaction to completion. This is important in the context where thermal curing is not available, for example, retrofit instances.

For example, it will be apparent that whilst new overhead conductors which are coated with a coating which requires thermal curing can be subjected to a thermal curing step as part of the manufacturing process, thermal curing raises considerable practical and economic problems if seeking to retrofit an existing overhead conductor in situ with a composition which cures to form a coating for the overhead conductor. Indeed, it will be appreciated that in many circumstances it will be impractical to attempt to retrofit a large overhead conductor network by seeking to cure the applied coatings at a temperature of from 150° C. up to 300° C. for a time period of, for example, 24 hours. It is therefore extremely useful that the sol-gel coating compositions of the present invention can be cured by other means and at ambient temperature.

It is also possible to integrate components into the coating composition such that the composition can be photocured. This allows for reduced processing energies and times and results in a fast one step, low energy process to cure the coatings on conductors.

Photopolymerization can be achieved by creating a photosol-gel polymerization. This is initiated by a photobase generator, a photosensitizer, and an oxygen scavenger. The photosensitiser may comprise an a-aminoketone, e.g. Omnirad 907 with a benzophenone. The oxygen scavenger may comprise triphenylphospine.

As discussed above, during the curing process all of the remaining precursor which is present in the coating composition will be converted into the product (i.e. the matrix), thereby forming a dry coating or film on the substrate (e.g. overhead cable). The final coating will therefore comprise essentially no precursor, and instead will comprise only a matrix comprising (preferably consisting of) silica, organically modified silica, titanium oxide, aluminium oxide, zirconium oxide and/or iron oxide, and an anti-corrosion component (i.e. anti-corrosion agent).

The present invention therefore provides a cured coating comprising:
a matrix which comprises silica, organically modified silica, titanium oxide, aluminium oxide, zirconium oxide, iron oxide or a combination thereof; and
an anti-corrosion agent, wherein the anti-corrosion agent is selected from an inhibitor pigment; a sacrificial pigment; a superhydrophobic agent; and combinations thereof.

The present invention therefore also provides an overhead cable which is at least partially coated with a cured coating, the coating comprising:
a matrix which comprises silica, organically modified silica, titanium oxide, aluminium oxide, zirconium oxide, iron oxide or a combination thereof; and
an anti-corrosion agent, wherein the anti-corrosion agent is selected from an inhibitor pigment; a sacrificial pigment; a superhydrophobic agent; and combinations thereof.

The matrix is preferably present in the cured coating of the present invention in the amount of at least about 50 wt. %, preferably at least about 70 wt. %, more preferably at least about 80 wt. % and most preferably at least about 90 wt. %.

The coating may have a thickness in the range of 1-10 μm, 10-20 μm, 20-30 μm, 30-40 μm, 40-50 μm, 50-60 μm, 60-70 μm, 70-80 μm, 80-90 μm, 90-100 μm, 100-110 μm, 110-120 μm, 120-130 μm, 130-140 μm or 140-150 μm.

After curing, the coating preferably has a thickness of from about 20 to about 120 μm, more preferably from about 30 to about 100 μm, even more preferably from about 35 to about 70 μm, and most preferably from about 40 to about 60 μm.

### Characteristics of Coated Conductors

As will be appreciated, the application of the single coating provides cables, such as overhead conductors, with a number of superior characteristics including anti-corrosion properties. That is, the coating of the present invention has an excellent corrosion resistance in contrast to other known coatings. This is at least partially due to the coating being mainly inorganic, rather than being a purely organic coating as has often been used in the prior art.

In addition to the anti-corrosion properties, the coating may provide an overhead cable with a uniform thickness around the exterior of the conductor or one or more conductive wires. That is, the application of the coating may compensate for differing amounts of unevenness in the cable.

The coating may also provide the conductor or one or more conductive wires with an increased mechanical strength relative to that of a bare conductor. For example, according to various embodiments a single coated conductor 400 or one or more conductive wires may have a minimum tensile strength of 10 MPa and may have a minimum elongation at break of 50% or more.

As another advantage, the coating may, in a similar manner to the arrangements disclosed in WO 2015/105972, serve as a protective layer against bird caging in the conductor or one or more conductive wires. As may be appreciated, bare or liquid coated conductors may lose their structural integrity over time and may become vulnerable to bird caging in any spaces between the conductor wire strands. In contrast, a conductor or one or more conductive wires which are coated by the coating of the present invention are shielded and may eliminate bird caging problems.

As another advantage, the coating in combination with a superhydrophobic agent may eliminate water penetration, may reduce ice and dust accumulation and may improve corona resistance.

As another advantage, a conductor or one or more conductive wires coated with the coating may have an increased heat conductivity, an increased emissivity and decreased absorptivity characteristics.

As an additional advantage, the coating may have a thermal deformation resistance at higher temperatures including temperatures of 140-150° C., 150-160° C., 160-170° C., 170-180° C., 180-190° C., 190-200° C., 200-210° C., 210-220° C., 220-230° C., 230-240° C., 240-250° C., 250-260° C., 260-270° C., 270-280° C., 280-290° C., 290-300° C. or >300° C.

Advantageously, the coating may maintain flexibility at lower temperatures and may have improved shrink back and low thermal expansion at the lower temperature range.

The addition of the coating may add relatively little weight to an overhead conductor. For example, the weight increase of a single coated overhead conductor according to a preferred embodiment of the present invention may be <5%, 5-10%, 10-15% or 15-20%.

Although the present invention has been described with reference to preferred embodiments, it will be understood by those skilled in the art that various changes in form and detail may be made without departing from the scope of the invention as set forth in the accompanying claims.

As used herein, the terms “comprises” and “comprising” include “consists essentially of” and “consisting essentially of”, or “consists of” and “consisting of”. Thus, any list given here which “comprises” certain elements may also “consists essentially of” or “consists of” said elements.

### Examples

A range of anti-corrosion coatings of the invention were manufactured and tested for performance and durability. The following tests were then performed on each sample:

Adhesion: Coating adhesion test involved creating a crosshatch on the surface with a crosshatch blade. Following this, tape was applied over the crosshatch to analyse how much material was removed from the tape test. The test was conducted on an aluminium Q-panel according to ASTM D 3359.

Temperature Stability: A coating sample on an aluminium Q-Panel was produced. The sample was inserted into an oven set at 150° C. for 7 days. The coating achieved a pass in this test if there was no film discoloration, cracking, flaking or chipping.

Acid Stability: Power lines operate at high temperature and are subject to high moisture environments either via humidity or rain. In regions where there are high level of pollutants in the atmosphere, particularly sulphur dioxide, this rain can have a lower pH and become acidic. It is important to demonstrate that the coatings are stable to moisture with a pH commensurate to acid raid without degrading. Normal rain typically has a pH of 5-5.5. Acid rain typically has a pH of around 4.

A coating sample on an aluminium Q-Panel was produced. The sample was inserted into an enclosed water bath. The pH of the water was lowered with 10% aqueous hydrochloric acid until the pH reached 4. The pH was monitored every 24 hours. The plate was submerged for 7 days. The plate was then inspected for degradation. The coating achieved a pass in this test if there was no film discoloration, cracking, flaking or chipping.

Corrosion Stability: The atmosphere in many regions can be highly corrosive, especially in desert and coastal atmospheres. To demonstrate stability against high salt content, the coating was totally immersed in a 10% NaCl brine solution for a period of 7 days. The coating achieved a pass in this test if there was no film discoloration, cracking, flaking or chipping.

Moisture Stability: Power lines generally operate at temperatures above 60° C. When there is local moisture due to rain, a simultaneous exposure to high temperature and moisture can damage many coatings. To test stability against this, a sample was inserted into water bath at 80° C. for 7 days. The coating achieved a pass in this test if there was no film discoloration, cracking, flaking.

### Reference Example 1

Binder A: Tetraethyl Orthosilicate (TEOS) was hydrolysed to 90% hydrolysis level using distilled water, 10% aq HCL and IPA as a solvent. This mixture was left to stir for 24 hours before use.

### Example 2

35.5 g of Binder A was mixed with 0.51 g of Rucosil BLS functionalised polysiloxane hydrophobising agent.

A dry pigment mix of 8.2 g of Mattex Pro Calcined Kaolin, 1.51 g Huecphos CMP inhibitor anticorrosion pigment (from Heubach GmbH), 3.30 g Silanos 290 silica and 0.75 g Garamite 7305 thickener (from BYK-Chemie GmbH) were added and dispersed with a high speed disperser at 8000 rpm until uniform.

This mixture was drawn down to 150 μm wet film thickness on sand blasted and solvent cleaned aluminium plates.

The tests described above were then carried out.

| Test | Result |
|---|---|
| Adhesion | 5 B |
| Temperature Stability | Pass. |
| | Pre-weight: 100.13 |
| | Post Weight: 100.13 |
| | No discoloration, flaking or chipping. |
| Acid Stability | Pass |
| | Pre-weight: 100.99 |
| | Post Weight: 100.92 |
| | No discoloration, flaking or chipping. |
| Corrosion Stability | Pass |
| | Pre-weight: 100.12 |
| | Post Weight: 100.17 |
| | No discoloration, flaking or chipping. |
| Moisture Stability | Pass |
| | Pre-weight: 100.93 |
| | Post Weight: 100.79 |
| | No discoloration, flaking or chipping. |

### Example 3

35.5 g of Binder A was mixed with 0.82 g of Rucosil BLS functionalised polysiloxane hydrophobising agent.

A dry pigment mix of 3.2 g of Mattex Pro Calcined Kaolin, 1 g 400 nm Rutile Titanium Dioxide, 3 g of Huecphos CMP anticorrosion agent (from Heubach GmbH), 3.30 g Silanos 290 silica and 0.12 g Garamite 7305 thickener (from BYK-Chemie GmbH) and 0.1 g Shepard Colour Black 10P950 were added and dispersed with a high speed disperser at 8000 rpm until uniform.

This mixture was drawn down to 150 μm wet film thickness on sand blasted and solvent cleaned aluminium plates.

The tests described above were then carried out.

| Test | Result |
|---|---|
| Adhesion | 5 B |
| Temperature Stability | Pass. |
| | Pre-weight: 100.64 |
| | Post Weight: 100.60 |
| | No discoloration, flaking or chipping. |
| Acid Stability | Pass |
| | Pre-weight: 101.13 |
| | Post Weight: 100.11 |
| | No discoloration, flaking or chipping. |
| Corrosion Stability | Pass |
| | Pre-weight: 100.74 |
| | Post Weight: 100.92 |
| | No discoloration, flaking or chipping. |
| Moisture Stability | Pass |
| | Pre-weight: 101.16 |
| | Post Weight: 100.63 |
| | No discoloration, flaking or chipping. |

### Example 4

35.5 g of Binder A was mixed with 0.75 g of Rucosil BLS functionalised polysiloxane hydrophobising agent.

A dry pigment mix of 3.2 g of Mattex Pro Calcined Kaolin, 1 g 400nm Rutile Titanium Dioxide, 3.30 g Silanos 290 silica and 0.12 g Garamite 7305 thickener (from BYK-Chemie GmbH) were added and dispersed with a high speed disperser at 8000 rpm until uniform. 14.27 g of Zinc Dust (ASTM Type II) was then added under stirring until a homogenous mix was formed.

This mixture was drawn down to 150 μm wet film thickness on sand blasted and solvent cleaned aluminium plates.

The tests described above were then carried out.

| Test | Result |
|---|---|
| Adhesion | 5 B |
| Temperature Stability | Pass. |
| | Pre-weight: 101.70 |
| | Post Weight: 101.70 |
| | No discoloration, flaking or chipping. |
| Acid Stability | Pass |
| | Pre-weight: 100.83 |
| | Post Weight: 100.89 |
| | No discoloration, flaking or chipping. |
| Corrosion Stability | Pass |
| | Pre-weight: 101.33 |
| | Post Weight: 100.40 |
| | No discoloration, flaking or chipping. |
| Moisture Stability | Pass |
| | Pre-weight: 100.93 |
| | Post Weight: 100.76 |
| | No discoloration, flaking or chipping. |

### Example 5

The following coating compositions (A-H) were applied to sandblasted aluminium or steel panels. The coating was cured under ambient conditions for 48 hours before any testing was initiated.

To test for corrosion, a cross was cut into the film using a scalpel. The panels were placed into a sealed enclosure (waterbath) which was set to a specified temperature (60.0° C.), which gave an atmosphere in the headspace of ˜40° C. and 90% relative humidity (% RH). The panels were suspended above the water and were never submerged.

The panels were periodically (approx. every 30 minutes) dusted with salt solution (5% w/w NaCl_{(aq)}) using a spray bottle. The salt water solution was sprayed into the atmosphere, not directly onto the panels, however it was allowed to settle on the panels in order to accelerate testing. The panels were subjected to three wet-dry cycles, and the degree of corrosion was evaluated by comparison to a standard. Comparison was carried out by utilising Lab colour space, and evaluating ΔE₂₀₀₀ between the sample and the standard.

The percentages given in the following formulations is wt. % based on the wet weight of the coating composition.

In each case, the silicate sol-gel binder was prepared by hydrolysing tetraethyl orthosilicate (TEOS) to 80-95% hydrolysis using distilled water and HCl, with IPA as a solvent. The amount of solvent within the silicate sol-gel binder was 70-90 wt. %.

### Composition A

Rutile titanium dioxide (11.7%), barium sulfate (1.0%), calcined kaolin (0.7%), anatase titanium dioxide (1.7%), silica (4.3%), and zinc phosphate (4.9%) were added to a slurry of a silicone acrylate copolymer-based surfactant (0.1%), an acidic copolymer-based dispersing agent (0.7%), and an organophilic clay rheology agent (1.3%) in isopropanol (23.7%) to form a millbase using a high speed disperser. Separately, a polysiloxane hydrophobic agent (1.1%) was added to the silicate sol-gel binder (48.7%) and mixed using a high speed mixer, after which the millbase was added with further mixing until a homogeneous dispersion was achieved.

### Composition B

Rutile titanium dioxide (10.8%), barium sulfate (1.0%), calcined kaolin (0.7%), anatase titanium dioxide (1.6%), silica (3.9%) and zinc calcium strontium aluminium orthophosphate silicate hydrate (4.9%) were added to a slurry of a silicone acrylate copolymer-based surfactant (0.1%), an acidic copolymer-based dispersing agent (0.7%), and an organophilic clay rheology agent (1.2%) in isopropanol (21.9%) to form a millbase using a high speed disperser. Separately, a polysiloxane hydrophobic agent (1.0%) was added to the silicate sol-gel binder (52.2%) and mixed using a high speed mixer, after which the millbase was added with further mixing until a homogeneous dispersion was achieved.

### Composition C

Rutile titanium dioxide (10.1%), barium sulfate (0.9%), calcined kaolin (0.6%), anatase titanium dioxide (1.5%), silica (3.7%), zinc calcium strontium aluminium orthophosphate silicate hydrate (4.5%), and a mixture of zinc oxide and zinc 5-nitroisopthalate (0.5%) were added to a slurry of a silicone acrylate copolymer-based surfactant (0.1%), an acidic copolymer-based dispersing agent (0.6%), and an organophilic clay rheology agent (1.1%) in isopropanol (20.4%) to form a millbase using a high speed disperser. Separately, a polysiloxane hydrophobic agent (1.0%) was added to the silicate sol-gel binder (54.9%) and mixed using a high speed mixer, after which the millbase was added with further mixing until a homogeneous dispersion was achieved.

### Composition D

Rutile titanium dioxide (10.6%), barium sulfate (0.9%), calcined kaolin (0.7%), anatase titanium dioxide (1.5%), silica (3.9%), and calcium phosphate (5.0%) were added to a slurry of a silicone acrylate copolymer-based surfactant (0.1%), an acidic copolymer-based dispersing agent (0.6%), and an organophilic clay rheology agent (1.2%) in isopropanol (21.5%) to form a millbase using a high speed disperser. Separately, a polysiloxane hydrophobic agent (1.0%) was added to the silicate sol-gel binder (52.9%) and mixed using a high speed mixer, after which the millbase was added with further mixing until a homogeneous dispersion was achieved.

### Composition E

Rutile titanium dioxide (10.3%), barium sulfate (0.9%), calcined kaolin (0.6%), anatase titanium dioxide (1.5%), silica (3.8%), and zinc oxide (4.9%) were added to a slurry of a silicone acrylate copolymer-based surfactant (0.1%), an acidic copolymer-based dispersing agent (0.6%), and an organophilic clay rheology agent (1.1%) in isopropanol (20.9%) to form a millbase using a high speed disperser. Separately, a polysiloxane hydrophobic agent (1.0%) was added to the silicate sol-gel binder (54.2%) and mixed using a high speed mixer, after which the millbase was added with further mixing until a homogeneous dispersion was achieved.

### Composition F

Rutile titanium dioxide (10.5%), barium sulfate (0.9%), calcined kaolin (0.7%), anatase titanium dioxide (1.5%), silica (3.8%), bis(trimethylsilyl)amine (HMDS)-functionalised fumed silica (1.0%), and zinc phosphate (3.0%) were added to a slurry of a silicone acrylate copolymer-based surfactant (0.1%), an acidic copolymer-based dispersing agent (0.7%), and an organophilic clay rheology agent (1.2%) in isopropanol (21.3%) to form a millbase using a high speed disperser. Separately, a polysiloxane hydrophobic agent (1.1%) was added to the silicate sol-gel binder (54.3%) and mixed using a high speed mixer, after which the millbase was added with further mixing until a homogeneous dispersion was achieved.

### Composition G

Rutile titanium dioxide (12.1%), barium sulfate (1.1%), calcined kaolin (0.8%), anatase titanium dioxide (1.8%), silica (4.4%) and zinc oxide (2.9%) were added to a slurry of a silicone acrylate copolymer-based surfactant (0.1%), an acidic copolymer-based dispersing agent (0.8%), and an organophilic clay rheology agent (1.3%) in isopropanol (24.6%) to form a millbase using a high speed disperser. Separately, a polysiloxane hydrophobic agent (1.0%) was added to the silicate sol-gel binder (49.0%) and mixed using a high speed mixer, after which the millbase was added with further mixing until a homogeneous dispersion was achieved.

### Composition H

Rutile titanium dioxide (11.4%), barium sulfate (1.0%), calcined kaolin (0.7%), anatase titanium dioxide (1.7%), silica (4.2%), mixture of calcium hydroxyphosphate and magnesium hydrogen orthophosphate (2.7%), and a mixture of zinc oxide and zinc 5-nitroisopthalate (0.3%) were added to a slurry of a silicone acrylate copolymer-based surfactant (0.1%), an acidic copolymer-based dispersing agent (0.7%), and an organophilic clay rheology agent (1.3%) in isopropanol (23.1%) to form a millbase using a high speed disperser. Separately, a polysiloxane hydrophobic agent (1.0%) was added to the silicate sol-gel binder (51.9%) and mixed using a high speed mixer, after which the millbase was added with further mixing until a homogeneous dispersion was achieved.

### Control Formulation

Rutile titanium dioxide (12.7%), barium sulfate (1.1%), calcined kaolin (0.8%), anatase titanium dioxide (1.9%) and silica (4.6%) were added to a slurry of a silicone acrylate copolymer-based surfactant (0.1%), an acidic copolymer-based dispersing agent (0.8%), and an organophilic clay rheology agent (1.4%) in isopropanol (25.7%) to form a millbase using a high speed disperser. Separately, a polysiloxane hydrophobic agent (1.1%) was added to the silicate sol-gel binder (50.1%) and mixed using a high speed mixer, after which the millbase was added with further mixing until a homogeneous dispersion was achieved.

### Corrosion Protection Results (Steel Substrate)

| | ΔE₂₀₀₀ (Pre- and | ΔE₂₀₀₀ (Comparison to |
|---|---|---|
| Composition | post-testing)* | standard)† |
| Control (no anti- | 34.55 | — |
| corrosion agent | | |
| A | 8.89 | 28.52 |
| B | 15.90 | 23.31 |
| C | 9.88 | 28.10 |
| D | 5.45 | 32.18 |
| E | 5.09 | 31.16 |
| F | 3.86 | 33.01 |
| G | 4.92 | 31.99 |
| H | 12.61 | 25.65 |

* When pre- and post-testing samples are compared, a low ΔE₂₀₀₀ indicates less colour change in the sample, and therefore increased corrosion protection.

† When two post-testing samples are compared, one containing an anti-corrosion agent, and the other absent the same, then a high ΔE₂₀₀₀ indicates a significant colour difference between the two, and should be taken as a measure of increased corrosion protection for the sample with the corrosion protection agent, as the sample absent a corrosion protection agent, in this case, always shows higher levels of corrosion and therefore deviation from the pristine.

On the aluminium panels, no discolouration blistering, cracking or peeling was observed.

### Preferred Embodiments

### Embodiment 1

A composition for coating an overhead conductor comprising:
a binder which comprises a solvent and silica, organically modified silica, titanium oxide, aluminium oxide, zirconium oxide, iron oxide or a combination thereof; and
an anti-corrosion agent, wherein the anti-corrosion agent is selected from an inhibitor pigment; a sacrificial pigment; a superhydrophobic agent; and combinations thereof.

### Embodiment 2

The composition of embodiment 1, wherein the composition comprises at least about 50 wt. % binder.

### Embodiment 3

The composition of embodiment 2, wherein the composition comprises at least 70 wt. % binder.

### Embodiment 4

The composition of embodiment 3, wherein the composition comprises at least about 80 wt. % binder.

### Embodiment 5

The composition of embodiment 4, wherein the composition comprises at least about 90 wt. % binder.

### Embodiment 6

The composition of any preceding embodiment, wherein the binder comprises at least about 50 wt. % silica, organically modified silica, titanium oxide, aluminium oxide, zirconium oxide, iron oxide or a combination thereof, based on the weight of the binder excluding the solvent.

### Embodiment 7

The composition of any preceding embodiment, wherein the binder comprises less than about 95 wt. % silica, organically modified silica, titanium oxide, aluminium oxide, zirconium oxide, iron oxide or a combination thereof, based on the weight of the binder excluding the solvent.

### Embodiment 8

The composition of any preceding embodiment, wherein the composition comprises about 5 to about 25 wt. % of silica, organically modified silica, titanium oxide, aluminium oxide, zirconium oxide, iron oxide or a combination thereof, based on the total weight of the composition.

### Embodiment 9

The composition of embodiment 8, wherein the composition comprises about 10 to about 25 wt. % of silica, organically modified silica, titanium oxide, aluminium oxide, zirconium oxide, iron oxide or a combination thereof.

### Embodiment 10

The composition of embodiment 9, wherein the composition comprises about 15 to about 25 wt. % of silica, organically modified silica, titanium oxide, aluminium oxide, zirconium oxide, iron oxide or a combination thereof.

### Embodiment 11

The composition of embodiment 10, wherein the composition comprises about 17 to about 23 wt. % of silica, organically modified silica, titanium oxide, aluminium oxide, zirconium oxide, iron oxide or a combination thereof.

### Embodiment 12

The composition of any preceding embodiment, wherein the composition comprises less than 50 wt. % anti-corrosion agent.

### Embodiment 12a

The composition of embodiment 12, wherein the composition comprises from about 1 to about 10 wt. % anti-corrosion agent.

### Embodiment 12b

The composition of embodiment 12a, wherein the composition comprises from about 2 to about 6 wt. % anti-corrosion agent.

### Embodiment 12c

The composition of embodiment 12b, wherein the composition comprises from about 3 to about 5 wt. % anti-corrosion agent.

### Embodiment 13

The composition of any preceding embodiment, wherein the binder comprises a solvent and silica or organically modified silica.

### Embodiment 14

The composition of any preceding embodiment, wherein the composition comprises 10 wt. % or less of water.

### Embodiment 14a

The composition of embodiment 14, wherein the composition comprises 5 wt. % or less of water.

### Embodiment 15

The composition of embodiment 14a, wherein the composition comprises 1 wt. % or less of water.

### Embodiment 16

The composition of embodiment 15, wherein the composition comprises 0.1 wt. % or less of water.

### Embodiment 17

The composition of any preceding embodiment, wherein the binder comprises from about 5 to about 50 wt. % of a precursor of silica, organically modified silica, titanium oxide, aluminium oxide, zirconium oxide, iron oxide or a combination thereof, based on the weight of the binder excluding the solvent.

### Embodiment 18

The composition of any preceding embodiment, wherein the binder comprises a solvent and (i) from about 70 wt. % to about 90 wt. % silica, organically modified silica, titanium oxide, aluminium oxide, zirconium oxide, iron oxide or a combination thereof; and (ii) from about 10 wt. % to about 30 wt. % of a precursor to component (i), based on the total weight of (i) and (ii).

### Embodiment 18a

The composition of embodiment 17 or 18, wherein the precursor is selected from the group consisting of a silicon alkoxide, an organosilane containing at least two (and preferably three) Si—O bonds, a titanium alkoxide, an aluminium alkoxide, a zirconium alkoxide, an iron alkoxide or a combination thereof.

### Embodiment 18b

The composition of embodiment 18a, wherein the silicon alkoxide has the formula Si(OR)₄, where each R is independently any suitable organic group, preferably an alkyl group.

### Embodiment 18c

The composition of embodiment 18b, wherein each R is independently C₁₋₈ alkyl, more preferably C₁₋₅ alkyl, and even more preferably methyl or ethyl.

### Embodiment 18d

The composition of embodiment 18a, wherein the organosilane has the formula SiR₂(OR)₂ or SiR(OR)₃, where each R is independently any suitable organic group, such as an alkyl, vinyl or epoxy group.

### Embodiment 18e

The composition of embodiment 18d, wherein the organosilane has the formula SiR₂(OR¹)₂ or SiR(OR¹)₃, where each R¹ group is independently any suitable organic group, and wherein each R group is independently any suitable organic group (such as an alkyl, vinyl or epoxy group).

### Embodiment 18f

The composition of embodiment 18e, wherein each R¹ group is an alkyl group.

### Embodiment 18g

The composition of embodiment 18e, wherein each R¹ group is a C₁₋₈ alkyl group.

### Embodiment 18h

he composition of embodiment 18e, wherein each R¹ group is a C₁₋₅ alkyl group.

### Embodiment 18i

The composition of embodiment 18e, wherein each R¹ group is methyl or ethyl.

### Embodiment 18j

The composition of any of embodiments 18e-18i, where each R group does not contain more than 16 non-hydrogen and non-fluorine atoms.

### Embodiment 18k

The composition of embodiment 18j, wherein where each R group does not contain more than 8 non-hydrogen and non-fluorine atoms.

### Embodiment 18l

The composition of embodiment 18e, wherein the organosilane is selected from the group consisting of methyltrimethoxy silane (MTMS), vinyltrimethoxysilane (VTMS), triethoxyvinylsilane (TEVS), trimethoxyphenylsilane, triethoxyphenylsilane, (3 aminopropyl)triethoxysilane (APTES), triethoxy(octyl)silane (C8-TEOS), 3 (2 aminoethylamino)propyldimethoxymethylsilane (AEAPS), (3 glycidyloxypropyl)trimethoxysilane (GPTMS), [3 (methacryloyloxy)propyl]trimethoxysilane (MAPTS), hexadecyltrimethoxysilane, (3 mercaptopropyl)trimethoxysilane (MPTMS), 1H,1H,2H,2H-perfluorooctyltriethoxysilane (FOTS), and 1H,1H,2H,2H-perfluorodecyltriethoxysilane (PFDTES).

### Embodiment 19

The composition of any preceding embodiment, wherein the binder comprises from about 50 wt. % to about 90 wt. % solvent.

### Embodiment 20

The composition of any preceding embodiment, wherein the binder comprises from about 60 wt. % to about 80 wt. % solvent.

### Embodiment 21

The composition of any preceding embodiment, wherein the composition comprises from about 25 wt. % to about 90 wt % solvent.

### Embodiment 22

The composition of any preceding embodiment, wherein the composition comprises from about 50 wt. % to about 90 wt % solvent.

### Embodiment 23

The composition of any preceding embodiment, wherein the composition comprises from about 60 wt. % to about 80 wt % solvent.

### Embodiment 24

The composition of any preceding embodiment, wherein the inhibitor pigment is selected from the group consisting of zinc oxide, niobium, boehmite, zinc molybdate, calcium molybdate, strontium molybdate, zinc phosphate, calcium phosphate, calcium-modified silica, zinc 5-nitroisopthalate, calcium hydroxyphosphate, magnesium hydrogen orthophosphate, calcium magnesium orthophosphate, calcium strontium phosphosilicate, zinc calcium strontium aluminium orthophosphate silicate, calcium aluminium polyphosphate silicate, strontium aluminium polyphosphate, zinc aluminium molybdenum orthophosphate, zinc aluminium polyphosphate, zinc molybdenum orthophosphate, and combinations thereof.

### Embodiment 25

The composition of any preceding embodiment, wherein the sacrificial pigment is selected from the group consisting of metallic zinc, metallic aluminium, and combinations thereof.

### Embodiment 26

The composition of any preceding embodiment, wherein the superhydrophobic agent is selected from the group consisting of a polymethylsilsesquioxane, a functional polysiloxane, or silica nanoparticles which have been surface modified with one or more hydrophobic silanes.

### Embodiment 27

The composition of embodiment 26, wherein the hydrophobic silane is selected from the group consisting of hexamethyldisilazane (HMDS), tetraethyl orthosilicate (TEOS), tetramethyl orthosilicate (TMOS), methyltrimethoxy silane (MTMS), vinyltrimethoxysilane (VTMS), trimethoxyphenylsilane, (3-aminopropyl)triethoxysilane (APTES), trimethylchlorosilane (TMCS), triethoxy(octyl)silane (C8-TEOS), 3-(2-aminoethylamino)propyldimethoxymethylsilane (AEAPS), (3-glycidyloxypropyl)trimethoxysilane (GPTMS), [3-(methacryloyloxy)propyl]trimethoxysilane (MAPTS), hexadecyltrimethoxysilane, (3-mercaptopropyl)trimethoxysilane (MPTMS), triethoxyphenylsilane, 1H,1H,2H,2H-perfluorooctyltriethoxysilane, trichloro(1H,1H,2H,2H-perfluorooctyl)silane (PFOCTS), 1H,1H,2H,2H-perfluorodecyltriethoxysilane (PFDTES), tridecafluorooctyltriethoxysilane, and combinations thereof.

### Embodiment 27a

The composition of embodiment 26, wherein the hydrophobic silane is selected from the group consisting of hexamethyldisilazane (HMDS), tetraethyl orthosilicate (TEOS), tridecafluorooctyltriethoxysilane, and combinations thereof.

### Embodiment 28

The composition of embodiment 26, wherein the functional polysiloxane is modified with one or more amine or fluoro-containing groups

### Embodiment 29

The composition of any preceding embodiment, wherein the anti-corrosion agent comprises a superhydrophobic agent.

### Embodiment 30

The composition of any preceding embodiment, wherein the anti-corrosion agent comprises an inhibitor pigment, a sacrificial pigment, and combinations thereof, optionally in combination with a superhydrophobic agent.

### Embodiment 30a

The composition of any preceding embodiment, wherein the anti-corrosion agent comprises a superhydrophobic agent and an inhibitor pigment; a superhydrophobic agent and a sacrificial pigment; or a superhydrophobic agent, an inhibitor pigment and a sacrificial pigment.

### Embodiment 30b

The composition of any preceding embodiment, wherein the composition comprises from about 1 to about 10 wt. % inhibitor pigment and/or sacrificial pigment (preferably inhibitor pigment) and from about 0.1 to about 5 wt. % superhydrophobic agent.

### Embodiment 30c

The composition of any preceding embodiment, wherein the composition comprises from about 2 to about 8 wt. % inhibitor pigment and/or sacrificial pigment (preferably inhibitor pigment) and from about 0.3 to about 3 wt. % superhydrophobic agent.

### Embodiment 30d

The composition of any preceding embodiment, wherein the coating composition comprises from about 2 to about 6 wt. % inhibitor pigment and/or sacrificial pigment (preferably inhibitor pigment) and from about 0.5 to about 2 wt. % superhydrophobic agent.

### Embodiment 30e

The composition of any preceding embodiment, wherein the anti-corrosion agent comprises a superhydrophobic agent and an inhibitor pigment; or a superhydrophobic agent, an inhibitor pigment and a sacrificial pigment.

### Embodiment 31

The composition of embodiment 30, wherein the anti-corrosion agent comprises an inhibitor pigment, optionally in combination with a superhydrophobic agent.

### Embodiment 32

The composition of any preceding embodiment, wherein the composition when cured forms a coating having a water contact angle (“WCA”) >150°.

### Embodiment 33

The composition of any preceding claim, wherein the composition further comprises a UV stabiliser.

### Embodiment 34

The composition of embodiment 33, wherein the UV stabiliser comprises a ultraviolet light absorber, preferably wherein the ultraviolet light absorber comprises 2-(2H-benzotriazol-2-yl)-p-cresol or 2-(4,6-Bis-(2,4-dimethylphenyl)-1,3,5-triazin-2-yl)-5-(octyloxy)-phenol.

### Embodiment 35

The composition of embodiment 33, wherein the UV stabiliser comprises a hindered amine light stabiliser, preferably wherein the hindered amine light stabiliser comprises bis(1-octyloxy-2,2,6,6-tetramethyl-4-piperidyl)sebacate or bis(1,2,2,6,6-pentamethyl-4-piperidyl)sebacate.

### Embodiment 36

The composition of any preceding embodiment, wherein the composition further comprises a curing agent.

### Embodiment 37

The composition of any preceding embodiment, wherein the composition further comprises a viscosity modifier and/or rheology agent, preferably wherein the viscosity modifier and/or rheology agent comprises a hydrophobically modified ethylenoxide urethane rheology modifier, an organoclay, a polyamide or fumed silica.

### Embodiment 38

The composition of any preceding embodiment, wherein the composition further comprises wetting agent and/or dispersion agent, preferably wherein the wetting agent and/or dispersion agent comprises a poly acrylic acid, a polyurethane, a polyacrylate, a phosphoric acid ester or a modified fatty acid.

### Embodiment 39

An overhead conductor at least partially coated with a composition as claimed in any preceding embodiment, wherein, in use, the composition is cured so as to form a coating on at least a portion of the overhead conductor.

### Embodiment 40

A cured coating comprising:
a matrix comprising silica, organically modified silica, titanium oxide, aluminium oxide, zirconium oxide, iron oxide or a combination thereof; and
an anti-corrosion agent, wherein the anti-corrosion agent is selected from an inhibitor pigment; a sacrificial pigment; a superhydrophobic agent; and combinations thereof.

### Embodiment 41

The coating of embodiment 40, wherein the coating comprises at least about 50 wt. % matrix.

### Embodiment 42

The coating of embodiment 41, wherein the coating comprises at least about 70 wt. % matrix.

### Embodiment 43

The coating of embodiment 42, wherein the coating comprises at least about 80 wt. % matrix.

### Embodiment 44

The coating of embodiment 43, wherein the coating comprises at least about 90 wt. % matrix.

### Embodiment 45

The coating of any of embodiments 40-44, wherein the coating has a thickness of from about 20 to about 120 μm.

### Embodiment 46

The coating of embodiment 45, wherein the coating has a thickness of from about 30 to about 100 μm.

### Embodiment 47

The coating of embodiment 46, wherein the coating has a thickness of from about 35 to about 70 μm.

### Embodiment 48

The coating of embodiment 47, wherein the coating has a thickness of from about 40 to about 60 μm.

### Embodiment 49

The coating of any of embodiments 40-48, wherein the anti-corrosion agent comprises a superhydrophobic agent.

### Embodiment 50

The coating of embodiment 49, wherein the coating has a water contact angle (“WCA”) >150°.

### Embodiment 51

The coating of any of embodiments 40-48, wherein the anti-corrosion agent comprises an inhibitor pigment, a sacrificial pigment, and combinations thereof, optionally in combination with a superhydrophobic agent.

### Embodiment 51a

The coating of any of embodiments 40-48, wherein the anti-corrosion agent comprises a superhydrophobic agent and an inhibitor pigment; a superhydrophobic agent and a sacrificial pigment; or a superhydrophobic agent, an inhibitor pigment and a sacrificial pigment.

### Embodiment 51b

The coating of any of embodiments 40-48, wherein the anti-corrosion agent comprises a superhydrophobic agent and an inhibitor pigment; or a superhydrophobic agent, an inhibitor pigment and a sacrificial pigment.

### Embodiment 52

The coating of embodiment 51, wherein the anti-corrosion agent comprises an inhibitor pigment, optionally in combination with a superhydrophobic agent.

### Embodiment 53

A method for forming a coating composition, the method comprising:
forming a binder which comprises a solvent and silica, organically modified silica, titanium oxide, aluminium oxide, zirconium oxide, iron oxide or a combination thereof by a sol-gel process;
adding an anti-corrosion agent, wherein the anti-corrosion agent is selected from an inhibitor pigment; a sacrificial pigment; a superhydrophobic agent; and combinations thereof.

### Embodiment 54

The method of embodiment 53, wherein the method comprises:
(i) at least partially hydrolysing a precursor selected from a silicon alkoxide, an organosilane, a titanium alkoxide, an aluminium alkoxide, a zirconium alkoxide, an iron alkoxide or a combination thereof;
(ii) at least partially polymerising the product of step (i) to form silica, organically modified silica, titanium oxide, aluminium oxide, zirconium oxide, iron oxide or a combination thereof; and
(iii) adding the anti-corrosion agent(s).

### Embodiment 55

A method for forming the coating of any of embodiments 40-52, the method comprising applying the coating composition of any of embodiments 1-38 to at least a portion of an overhead conductor, and allowing the composition to cure.

### Embodiment 56

The method of embodiment 55, wherein the step of allowing the composition to cure comprises allowing the composition to cure solely by moisture curing so as to form a coating or film on at least a portion of the overhead conductor.

### Embodiment 57

The method of embodiment 55 or 56, wherein the step of allowing the composition to cure does not involve heating the composition above ambient temperature.

### Embodiment 58

The method of embodiment 55 or 56, wherein the step of allowing the composition to cure comprises maintaining the temperature of the composition and the coating being formed on the overhead conductor below 100° C.

### Embodiment 59

The method of embodiment 58, wherein the step of allowing the composition to cure comprises maintaining the temperature of the composition and the coating being formed on the overhead conductor below 90° C.

### Embodiment 60

The method of embodiment 59, wherein the step of allowing the composition to cure comprises maintaining the temperature of the composition and the coating being formed on the overhead conductor below 80° C.

### Embodiment 61

A kit for forming a composition for coating an overhead conductor comprising:
a first part comprising a precursor selected from a silicon alkoxide, an organosilane, a titanium alkoxide, an aluminium alkoxide, a zirconium alkoxide, an iron alkoxide or a combination thereof; and
a second part comprising an anti-corrosion agent, wherein the anti-corrosion agent is selected from an inhibitor pigment; a sacrificial pigment; a superhydrophobic agent; and combinations thereof.

### Embodiment 62

A method of retro-fitting an overhead power transmission or distribution line comprising one or more overhead conductors, the method comprising:
applying a composition according to any of embodiments 1 to 38 on to at least a portion of an overhead conductor.

### Embodiment 63

The method of embodiment 62, wherein the method further comprises allowing the composition to cure.

### Embodiment 64

An overhead conductor at least partially coated with the cured coating of any of embodiments 40-52.

1. A composition for coating an overhead conductor comprising:
a binder which comprises a solvent and silica, organically modified silica, titanium oxide, aluminium oxide, zirconium oxide, iron oxide or a combination thereof; and
an anti-corrosion agent, wherein the anti-corrosion agent is selected from an inhibitor pigment; a sacrificial pigment; a superhydrophobic agent; and
combinations thereof.

2. The composition of claim 1, wherein the composition comprises about 5 to about 25 wt. % of silica, organically modified silica, titanium oxide, aluminium oxide, zirconium oxide, iron oxide or a combination thereof.

3. (canceled)

4. The composition of claim 1, wherein the binder comprises a solvent and silica or organically modified silica.

5. The composition of claim 1, wherein the composition comprises 1 wt. % or less of water.

6. The composition of claim 1, wherein the composition comprises at least about 45 wt. % binder, preferably at least about 50 wt. % binder, preferably at least about 70 wt. % binder, more preferably at least about 80 wt. % binder, more preferably at least about 90 wt. % binder.

7. The composition of claim 1, wherein the composition comprises from about 2 to about 6 wt. % anti-corrosion agent.

8. The composition of claim 1, wherein the binder comprises a solvent and (i) from about 70 wt. % to about 90 wt. % silica, organically modified silica, titanium oxide, aluminium oxide, zirconium oxide, iron oxide or a combination thereof; and (ii) from about 10 wt. % to about 30 wt. % of a precursor to component (i), based on the weight of (i) and (ii).

9. The composition of claim 1, wherein the inhibitor pigment is selected from the group consisting of zinc oxide, niobium, boehmite, zinc molybdate, calcium molybdate, strontium molybdate, zinc phosphate, calcium phosphate, calcium-modified silica, zinc 5-nitroisopthalate, calcium hydroxyphosphate, magnesium hydrogen orthophosphate, calcium magnesium orthophosphate, calcium strontium phosphosilicate, zinc calcium strontium aluminium orthophosphate silicate, calcium aluminium polyphosphate silicate, strontium aluminium polyphosphate, zinc aluminium molybdenum orthophosphate, zinc aluminium polyphosphate, zinc molybdenum orthophosphate, and combinations thereof.

10. The composition of claim 1, wherein the sacrificial pigment is selected from the group consisting of metallic zinc, metallic aluminium, and combinations thereof.

11. The composition of claim 1, wherein the superhydrophobic agent is selected from the group consisting of a polymethylsilsesquioxane, a functional polysiloxane, or silica nanoparticles which have been surface modified with one or more hydrophobic silanes.

12. (canceled)

13. The composition of claim 1, wherein the anti-corrosion agent is selected from an inhibitor pigment, a sacrificial pigment, and combinations thereof, optionally in combination with a superhydrophobic agent.

14. The composition of claim 1, wherein the anti-corrosion agent is an inhibitor pigment, optionally in combination with a superhydrophobic agent.

15. (canceled)

16. (canceled)

17. (canceled)

18. (canceled)

19. An overhead conductor at least partially coated with the composition of claim 1, wherein, in use, the composition is cured so as to form a coating on at least a portion of the overhead conductor.

20. A coating comprising:
a matrix comprising silica, organically modified silica, titanium oxide, aluminium oxide, zirconium oxide, iron oxide or a combination thereof; and
an anti-corrosion agent, wherein the anti-corrosion agent is selected from an inhibitor pigment; a sacrificial pigment; a superhydrophobic agent; and
combinations thereof.

21. The coating of claim 20, wherein the coating comprises at least about 50 wt. % matrix, preferably at least about 70 wt. % matrix, more preferably at least about 80 wt. % matrix, more preferably at least about 90 wt. % matrix.

22. The coating of claim 20, wherein the coating has a thickness of from about 20 to about 120 μm, preferably from about 30 to about 100 μm.

23. (canceled)

24. A method for forming a coating composition, the method comprising:
forming a binder which comprises a solvent and silica, organically modified silica, titanium oxide, aluminium oxide, zirconium oxide, iron oxide or a combination thereof by a sol-gel process;
adding an anti-corrosion agent, wherein the anti-corrosion agent is selected from an inhibitor pigment; a sacrificial pigment; a superhydrophobic agent; and
combinations thereof.

25. The method of claim 24, wherein the method comprises:
(i) at least partially hydrolysing a precursor selected from a silicon alkoxide, an organosilane, a titanium alkoxide, an aluminium alkoxide, a zirconium alkoxide, an iron alkoxide or a combination thereof;
(ii) at least partially polymerising the product of step (i) to form silica, organically modified silica, titanium oxide, aluminium oxide, zirconium oxide, iron oxide or a combination thereof; and
(iii) adding the anti-corrosion agent(s).

26. (canceled)

27. (canceled)

28. (canceled)

29. (canceled)

30. A kit for forming a composition for coating an overhead conductor comprising:
a first part comprising a precursor selected from a silicon alkoxide, an organosilane, a titanium alkoxide, an aluminium alkoxide, a zirconium alkoxide, an iron alkoxide or a combination thereof; and
a second part comprising an anti-corrosion agent, wherein the anti-corrosion agent is selected from an inhibitor pigment; a sacrificial pigment; a superhydrophobic agent; and combinations thereof;
wherein, in use, the first and second parts are mixed together to form a composition which is applied to at least a portion of an overhead conductor and allowed to cure in order to form a coating on at least a portion of the overhead conductor.

31. (canceled)

32. A method of retro-fitting an overhead power transmission or distribution line comprising one or more overhead conductors, the method comprising:
applying the composition according of claim 1 on to at least a portion of an overhead conductor, preferably wherein the method further comprises allowing the composition to cure.

33. (canceled)
